(19) United States
(12) Patent Application Publication
(10) Pub. No.: US 2006/0087936 A1
(43) Pub. Date: Apr. 27, 2006

(54) Data capture device and method of storing data

(76) Inventor: Gary Bart, Miramar, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/971,603

(22) Filed: Oct. 21, 2004

(51) Int. Cl. G11B 5/09

(52) U.S. Cl. 369/47.1; 369/59.1

(57) ABSTRACT

A data capture device that connects to a data storage device so as to share common components necessary for proper operation of both devices and to minimize the number of individual components necessary to store data obtained by the data capture device in the data storage device is provided. A method of storing data obtained by a data capture device in a data storage device is also provided. A preferred embodiment of the inventive data capture device includes the basic components of a digital camera that connects to the data storage device, which is an MP3 player. The data capture device obtains and digitizes images and transfers the binary image data to the MP3 player through a communications unit (connection) for storage in the MP3 player and for real-time display of the images on the LCD of the MP3 player. The connection between the MP3 player and the data capture device also enables digital control commands to be transferred from the MP3 player to the data capture device, allowing the MP3 control interface to be used also as the control interface for the data capture device.

### FIELD OF THE INVENTION

The present invention relates generally to data capture devices and methods of storing data. More specifically, the present invention is concerned with still image capture devices (such as digital cameras), video recording devices, audio recording devices, live video/audio capture devices (i.e. for recording on-line chat audio/video sessions), and other data capture devices that utilize a digital music or media player (such as the iPod by Apple) as a data storage medium, display and/or control panel for the data capture device.

### BACKGROUND OF THE INVENTION

Digital music/media players, such as MP3 players and the like, have become extremely popular in recent years, as they provide users with the ability to store and play numerous songs and other media in a small, usually handheld, device. MP3 is shorthand for “mpeg-1 audio layer 3”, which is a digital audio compression algorithm that achieves a compression factor of about ten to fourteen while maintaining near-CD sound quality. MP3 format allows users to download a song from the Internet to a computer, or from a computer to an MP3 player, in minutes rather than hours, and to store hundreds of songs on a computer's hard disk, or in an MP3 player, using very little storage space.

Media players such as MP3 players generally include a data port, internal memory, a microprocessor, a digital signal processor (DSP), a display, playback controls (mechanical user interface), an audio port, an amplifier, and a power supply. The data port of an MP3 player connects to a port on a computer (such as a USB port, FireWire port or parallel port) to transfer data (i.e. MP3 files or firmware upgrades) from the computer to the MP3 player, and the data is saved in the player's memory.

MP3 player memory types can include internal flash memory, CompactFlash cards, SmartMedia cards, Memory Stick, and Internal microdrives. Internal flash memory, CompactFlash cards, SmartMedia cards, Memory Stick are all types of solid state memory and contain no moving parts. Microdrives are basically hard drives, which contain moving parts, but that can store 10 to 150 times more data than solid state memory devices. The Apple iPod is an example of an MP3 or digital music/media player that uses as its primary storage medium, a hard disk drive to take advantage of the high storage capacity offered by such a storage medium.

The microprocessor of an MP3 player monitors user input through the playback controls, displays song information and graphical user control menus on the LCD panel, and sends directions to the DSP chip to control the audio processing. The DSP reads the song data from the memory, runs a decompression algorithm uncompress the MP3 file, converts the uncompressed digital data to analog waves, applies any special effects, or EQ, and sends the analog wave to the amplifier. The amplifier boosts the strength of the signal and sends it to the audio port, where a pair of headphones, or speakers, are connected.

The data port, audio port and power supply for many MP3 players, such as the iPod, usually comprise specially designed connectors which provide various methods of data communications with the MP3 player (i.e. between the MP3 player and a computer, as well as between the MP3 player and accessories or other devices for the MP3 player), supplies power to accessories, and accept incoming power to charge the MP3 players' batteries. MP3 players, such as the iPod, generally utilize proprietary languages to carry out communications between the MP3 player and the various devices to which they connect. In current MP3 players (such as the iPod), the LCD is usually a monochrome display to show textual information such as device control menus and song titles. Nevertheless, such devices could be constructed to display color images and navigate through stored images.

Current accessories for connecting to MP3 players, such as the iPod, include external speaker units, media readers, and digital voice recorders. External speaker units generally plug into the audio port of the MP3 player to provide amplified sound as an alternative to using headphones. The external speaker units include units designed specifically to the MP3 player, which connect directly to the audio port, and which often also act as a docking/charging station for the MP3 player. Other external speaker units can be connected to the audio port of the MP3 player by a hard wire connection to an audio in port on the speaker unit. These can include virtually any stereo tuner that has audio inputs. They may also include stereos with tape players that are connected to the MP3 player by a cassette adapter wired to the audio port of the MP3 player. Yet other external speaker units comprise radio transmitters, such as an FM transmitter, that connects to the audio port of the MP3 player and transmits the song being played to a radio, such as a car radio.

All of the external speaker unit accessories described above simply receive the analog audio signal that is generated by the MP3 player and either amplify or transmit that signal so that it can be played by the external speakers. None of these units store any data on the MP3 player. Media readers and digital voice recorders allow users to store certain types of data on the MP3 player.

A media reader allows the user to download data files from a solid state memory source, such as a flash memory card from a digital camera, and store those files on the hard drive of the MP3 player. While a media reader does allow the user of an MP3 player to utilize the storage capacity of the MP3 player to free up space in the user's digital camera storage media, it still requires the user to have three separate devices: 1) the digital camera, 2) the media reader, and 3) the MP3 player. Therefore, it would be beneficial to provide a method and apparatus for utilizing the storage capacity of an MP3 player, or other similar device, for storage of data captured by a data capture device such as a digital camera that reduces the number of components carried by the user.

Furthermore, the prior art, in which a user must have both an MP3 player and a digital camera, or other data capture device, results in the user carrying multiple devices that often contain many of the same or similar hardware components. For example, most data capture devices (such as digital cameras) generally include a LCD, similar to the LCD of an MP3 player, for displaying images in real time of the image that will be captured (when image data is the type of data being captured), information about the data that is captured (i.e. time, date, title, etc.), and user control menus. In addition, most data capture devices, include a mechanical user control interface similar to that of an MP3 player, such as a power button, white balance control, battery check button, shutter button, mode setting button, etc. for a camera. Also, data capture devices, such as digital cameras, generally include a medium to store the data that is captured by the device similar to the memory storage mediums of MP3 players. Therefore, it would be beneficial to provide a method and apparatus for utilizing these similar components between the data capture device, and the media player (i.e. MP3 player), so as to minimize the overall size of the devices carried by the user.

A digital voice recorder accessory for an MP3 player, is a data capture device that utilizes the controls of the MP3 player to capture data and store that data directly in the MP3 player. Such a device is simply an audio sensor that is connected the audio port of the MP3 player and controlled and powered by the MP3 player. These devices generally record lower quality, mono, sound files. The processor of the MP3 player and its software (or firmware) use the microphone to obtain an analog audio signal that is converted to a digital format by the processor and stored (usually as an uncompressed WAV file) in the MP3 player. While such a method is acceptable for relatively lower quality sound recordings, higher quality audio as well as video images cannot be handled in this manner. To input higher quality audio and video images directly from a sensor, such as a CCD (charge coupled device) of a digital camera or a microphone, into an MP3 player (or similar device), requires capability of an extremely high data transfer rate through the input of the MP3 player (in the case of the microphone, the input is the audio port). Therefore, it would be beneficial to provide a method and apparatus for capturing and storing high quality audio and/or video (still and motion) device such as an MP3 player.

### SUMMARY OF THE INVENTION

The present invention comprises data capture devices that connect to data storage devices, and methods of storing data which eliminate many of the disadvantages of the prior art. The benefits of the instant invention are accomplished through the use of a data capture device that connects to a data storage device so as to share common components necessary for proper operation of both devices and to minimize the number of individual components necessary to store data obtained by the data capture device in the data storage device.

The data storage device utilized in connection with the instant invention is a non-dedicated storage device, such as an MP3 player or other media player. Such devices are deemed “non-dedicated” as they are capable of functions separate and apart from the data capture devices of the instant invention. For example, an MP3 player is capable of storing and replaying MP3 formatted songs independently, without the use of the data capture device of the instant invention.

The data capture device of the instant invention comprises the appropriate components (sensors) for obtaining or capturing the desired data that are not otherwise present in the data storage device. For example, a data capture device for capturing image data (i.e. a digital camera) includes the basic features of a digital camera (still image or video) including optics, a flash, an image sensor (such as a CCD—charge coupled device—chip or CMOS—complementary metal oxide semiconductor), a power source, a data buffer, and related supporting components and circuitry (such as an ADC—analog to digital converter—, and processor to convert the analog image data measured by the image sensor to binary form).

While, most digital cameras generally have an LCD built in upon which the user can preview, in real-time, a video display of the image that would be captured when the user presses the shutter, the digital camera embodiment of the data capture device of the instant invention does not include an LCD. Instead the digital camera embodiment will utilize the LCD contained in the data storage device to display images. The digital camera embodiment of the instant invention also does not include all of the control buttons generally located on prior art digital cameras (although it may include some control buttons without departing from the spirit or scope of the instant invention), as the camera of the instant invention will utilize the control interface from the data storage device. In addition, the digital camera embodiment of the instant invention does not include the data storage medium in which the digitized (binary) image data is stored, as it utilizes the storage medium of the data storage device to store the binary image data.

In a digital camera embodiment of the instant invention, the connection between the camera and the data storage device, as well as appropriate software commands to control the LCD of the data storage device, allows the LCD of the data storage device to display a preview of the image that will be captured by the camera when the user presses the shutter button. After the camera has digitized the image, the camera transfers the digitized image data through the connection to the data storage device for display on the LCD.

As the digital camera embodiment of the instant invention utilizes the LCD of the data storage device, an on screen menu system to control camera functions, which may include the following: power on/off, capture image (shutter), flash on/off, white balance, battery check, etc., is displayed on the LCD screen of the data storage device, and those on-screen functions are controlled by the controls of the data storage device. When a user operates the controls of the data storage device, digital code is transferred from the data storage device to the data capture device to operate the desired data capture device functions.

Captured data (such as image data in the camera embodiment) is stored directly on the data storage medium of the data storage device (such as a hard disk in an iPod) by transferring the digital data through the connection (in the iPod embodiment this is done using the Apple proprietary connection) and appropriate data communication protocols used by the data storage device. To effect a proper transfer of captured data from the data capture device to the data storage device, while minimizing the delay between the ability to capture data multiple times (i.e. taking multiple pictures in a short period of time), a preferred embodiment of the data capture device of the instant invention employs a data buffer, directly addressable by the data sensor (such as a CCD in a camera embodiment). In yet another preferred embodiment, once the data is in the buffer a micro controller unit of the data capture device utilizes a DSP (digital signal processor) to compress and encode the data to a second buffer and then transfer a copy of the data from the second buffer, through the connection between the data capture device and the data storage device, directly to the data storage medium of the data storage device.

A preferred embodiment of the data capture device of the instant invention includes its own power source, such as batteries to power the various data capture, digitizing and compression functions. This is particularly useful for the digital camera and video camera embodiments of the instant invention, which have substantial power requirements.

Although discussed primarily in connection in connection with a digital camera embodiment, it will be appreciated that the data capture devices of the instant invention may include still image capture devices, video recording devices, audio recording devices, live video/audio capture devices (as used in on-line chat video/audio sessions), or any other data capture devices now known or later developed.

In a preferred embodiment of the instant invention, the data capture device includes a speaker for audio playback of either captured data, or other audio data (such as MP3 files) already stored on the data storage device.

In yet another preferred embodiment of the instant invention, the data capture device functions as a housing or support for the data storage device, such that the data capture device and the data storage device operate as a single physical unit.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is schematic diagram of a digital camera embodiment of the data capture device of the instant invention for use in connection with an MP3 player.

FIG. 2 is a front perspective view of a digital camera embodiment of the instant invention connected with an MP3 player for operation.

FIG. 3 is a rear perspective view of the digital camera of FIG. 2.

FIG. 4 is a front perspective view of a front half of the data capture device shown in FIGS. 2 and 3.

FIG. 5 is a rear perspective view of the front half of the data capture device shown in FIG. 4.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

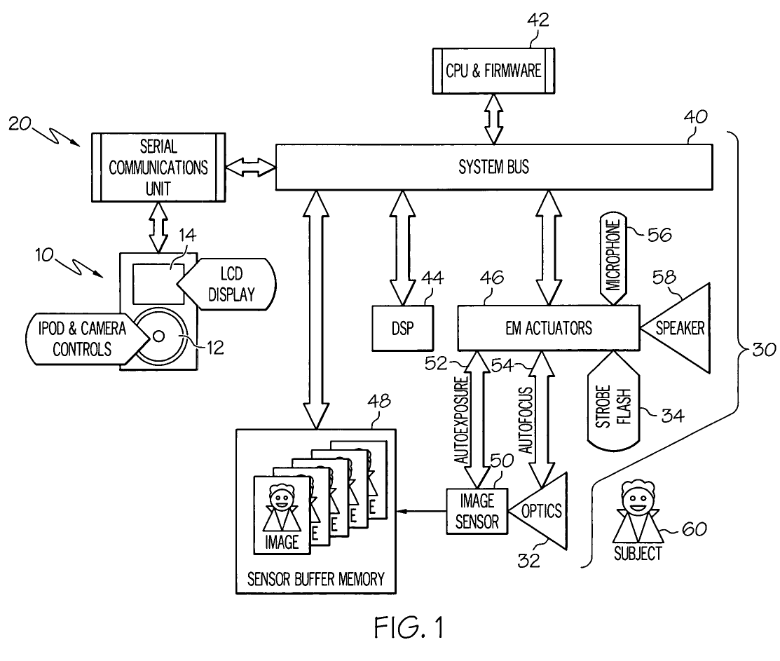

Referring to FIG. 1, a schematic diagram of a digital camera embodiment of data capture device 30 of the instant invention is shown connected to MP3 player 10. System bus 40 of data capture device 30 is connected to MP3 player 10 through serial communications unit 20. System bus 40 connects together the basic digital camera components of data capture device 30.

MP3 player 10, shown in FIG. 1 is a non-dedicated data storage device, such as an Apple iPod, that it is capable of functions separate and apart from data capture device 30, such as storing and replaying MP3 formatted songs independently, without the use of data capture device 30 of the instant invention. MP3 player 10 includes color LCD display 14, control interface 12, a combination earphone/headphone/remote jack (not shown), a hold (control interface lockout) switch (not shown), and a data port or serial communications connection (not shown). Although shown and described in connection with an MP3 player, it will be appreciated that any non-dedicated data storage devices now known or hereafter developed can be utilized as alternatives to MP3 player 10 without departing from the spirit and scope of the instant invention, including but not limited to alternative format music players and video players.

The digital camera embodiment of data capture device 30 shown in FIG. 1 is constructed in a similar fashion to digital cameras of the prior art, with a primary exception being that the elimination of the LCD display (and related circuitry—i.e. digital to analog conversion circuitry to convert binary data to display the image on the LCD), control buttons, and image data storage medium. CPU 42 is connected through system bus 40 to control and access components such as electro-mechanical actuators 46, sensor buffer memory 48, and digital signal processor 44. The operations of CPU 42 are controlled by firmware that is either stored in CPU 42 or alternatively stored in a separate data storage medium that is accessed by CPU 42. Electro-mechanical actuators 46 are selectively controlled by CPU 42 to actuate auto-focus 54 to control/adjust optics 32, to actuate auto-exposure controls 52 to control/adjust image sensor 50, and to actuate flash 34, microphone (audio sensor) 56, and/or speaker 58. A power source (such as batteries, not shown) may also be connected to system bus 40, to provide power necessary to operate the components of data capture device 30. Alternatively, power can be supplied by MP3 player 10 through serial communications unit 20.

The design and construction of the components of data capture device 30 will be readily apparent to those skilled in the art and can include components now known or hereinafter developed. For example, image sensor 50 may be a CCD, CMOS, or any other suitable image sensor, and the camera may utilize beam splitters, spinning disks, interpolation, Bayer filters, demosaicing algorithms, or other methods for capturing color. Audio sensor may be a directional or non-directional microphone, or any other suitable audio sensor to obtain the desired sensitivity. Optics 32 can be auto-focus as shown, fixed-focus, fixed-zoom, digital-zoom, optical-zoom, macro-zoom, or manual focus, and can include any focal length and may be replaceable or non-replaceable.

In the embodiment shown in FIG. 1, serial communications unit 20 is a plug and socket type connection, such as a proprietary docking connection currently used on Apple iPods. Nevertheless, it will be appreciated that alternative embodiments of the instant invention may utilize any type of connection that permits data transfer between data capture device 30 and MP3 player 10 without departing from the spirit or scope of the instant invention. Other such connections include non-proprietary plug and socket connections and cables including USB connections, FireWire connections, parallel connections, wireless or blue-tooth connections, and the like.

In a preferred embodiment of the instant invention, data capture device is configured (through hardware components and/or firmware routines) to store data to a hard disk of MP3 player 10. Nevertheless, it will be appreciated that alternative embodiments may be configured to work with any type of (non-volatile) memory now known or hereafter developed, such as flash, CD, DVD, magnetic disk, MRAM (magnetic ram), and the like.

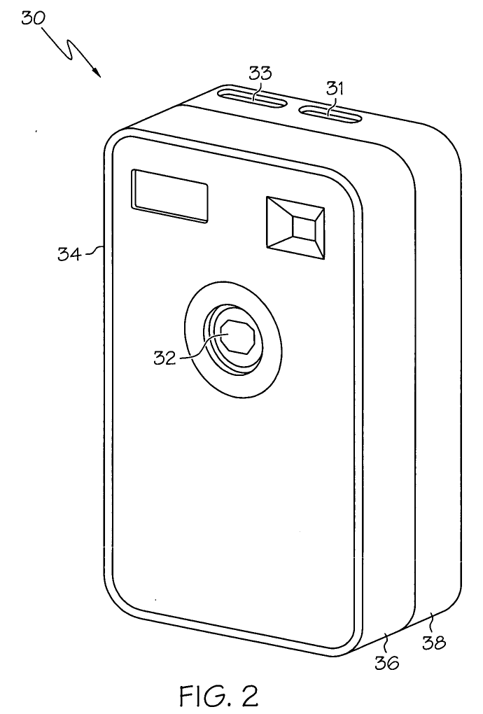

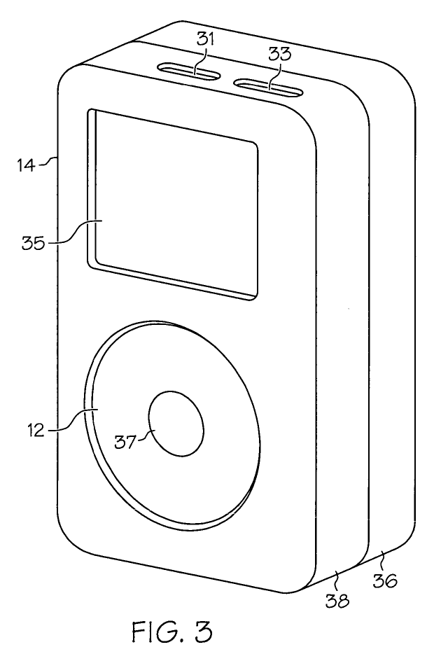

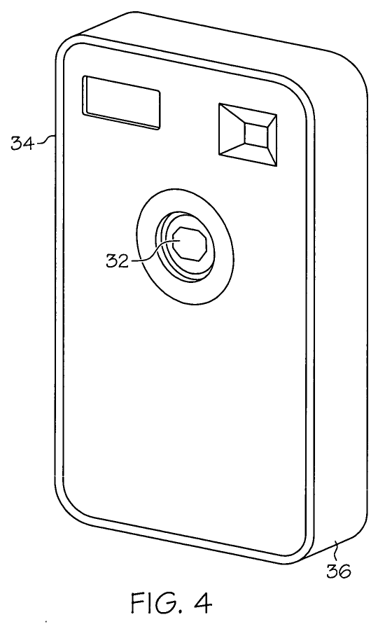

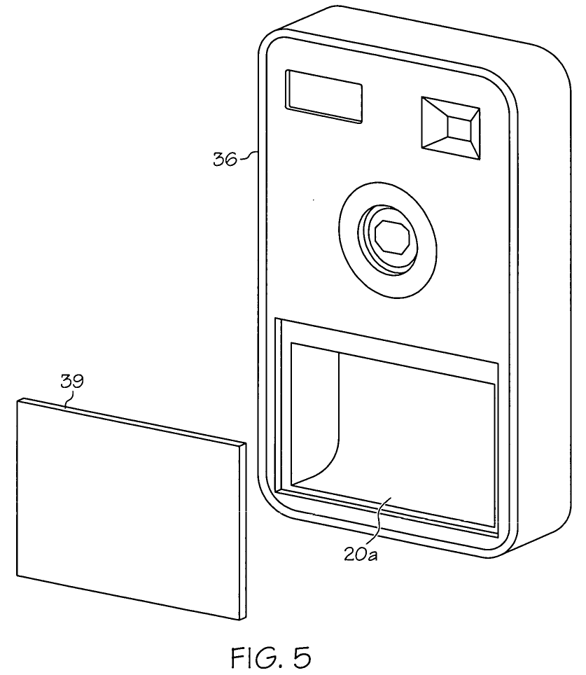

FIGS. 2-5 show various views of a digital camera embodiment of data capture device 30 of the instant invention. As is shown in FIGS. 2 and 3, data capture device 30 includes front half section 36 and back half section 38. Front half section 36 includes all of the functional components of data capture device 30 described above in connection with FIG. 1, including CPU 42, system bus 40, electro-mechanical actuators 46, sensor buffer memory 48, digital signal processor 44, auto-focus 54, optics 32, auto-exposure controls 52, image sensor 50, flash 34, microphone (audio sensor) 56 (not shown in this embodiment), and speaker 58 (not shown in this embodiment). As is shown in FIG. 5, battery access cover 39 is provided on the rear side of front half 36 to access and replace batteries that provide power necessary to operate the components of data capture device 30.

As is shown in FIG. 5, the rear side of front half 36 of data capture device 30 includes plug connector 20a for connecting to a socket connector (not shown) located on the back side of MP3 player 10 to form serial communications unit (connector) 20. Once MP3 player 10 is connected to plug connector 20, back half section 38 of data capture device is connected to front half section 36. Back half section 38 is hollow so as to surround MP3 player 10 when MP3 player 10 is connected and data capture device 30 is fully assembled. Back half section 38 of data capture device 30 includes portal 37 to expose control interface 12 so that a user can manipulate control interface 12 to take pictures. Back half section 38 further includes portal 31 for exposing a combination earphone/headphone/remote jack of MP3 player 10, portal 33 for exposing a hold (control interface lockout) switch of MP3 player 10, and view portal 35 for exposing LCD 14 of MP3 player 10. In an alternative embodiment, portals 37, 31, 33, and 35 all can be covered by a clear, thin material, so long as the material does not prevent the user's operation of the various controls, or otherwise hinder the user's ability to view images on LCD 14.

Operation of the digital camera embodiment of data capture device 30 shown in FIG. 1 is similar or identical to operation of a standard, auto-focus, auto-exposure digital camera. The only difference being that the user operates the shutter of the digital camera of the instant invention by depressing a button on controls 12 of MP3 player 10 instead of a button on the camera. Nevertheless, it will be appreciated that a separate shutter button could be included on the outer shell of data capture device and connected to system bus 40 so as to provide the shutter control button in a standard location that is easy to operate.

The user of simply points data capture device 30 at subject 40 and auto-focus 54 will be controlled by CPU 42 (through actuators 46) to focus optics 32. The amount of light to which image sensor 50 is exposed through optics 32 is controlled by auto-exposure 52. Image sensor 50 obtains image data in analog form. CPU 42 functions as an ADC to convert the analog image data measured by image sensor 50 to a binary format, and places the binary image data in sensor buffer memory 48. CPU 42 then utilizes DSP 44 to compress and encode the binary image data into a second image buffer (shown in FIG. 1 as part of DSP 44). CPU 42 then transfers a copy of the binary, compressed and encoded image data to MP3 player 10 through serial communications unit 20. In the event the camera of the instant invention is set to display in real-time on LCD 14 the image that would be captured when the user presses the shutter button, the copy of the compressed and encoded binary image data will be transferred to LCD display 14 without being captured and stored on the data storage medium of MP3 player 10. To obtain a 720×486 real-time image view on LCD 14 it is preferred to achieve a sustained transfer rate between to the display of above 3.3 meg/second. When the shutter button is activated, the copy of the compressed and encoded binary image data will be transferred directly to the data storage medium of MP3 player 10.

In the embodiment of the digital camera shown in FIGS. 1-5, MP3 controls 12 control all functions of data capture device 30. Thus, when a user selects a function for the camera, either by a direct control button, or by selecting a function from an on screen menu system that may be displayed on LCD 14, binary code is transferred from MP3 player 10 to data capture device 30. The binary code is received by CPU 42, which then initiates the desired function instructed by the code. Camera functions that may be controlled in this manner include, but are not limited to, the following: power on/off, capture image (shutter), flash on/off, white balance, battery check, etc.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A data capture device comprising:
a data sensor;
a processor for converting sensed data to a binary format; and
a serial communications unit for transferring binary code between the data capture device and a data storage device.

2. The data capture device as claimed in claim 1 wherein said data sensor comprises an image sensor.

3. The data capture device as claimed in claim 2 wherein said image sensor is a CCD.

4. The data capture device as claimed in claim 2 wherein said serial communications unit transfers binary code comprising image data to an LCD display of the data storage device.

5. The data capture device as claimed in claim 2 wherein said serial communications unit transfers binary code comprising image data to a data storage medium of the data storage device.

6. The data capture device as claimed in claim 1 wherein said serial communications unit transfers binary code comprising control commands from the data storage device to said data capture device.

7. The data capture device as claimed in claim 1 wherein said serial communications unit comprises a plug and socket connection between the data storage device and said data capture device.

8. The data capture device as claimed in claim 1 further comprising a housing for supporting the data storage device.

9. The data capture device as claimed in claim 8 wherein said housing is adapted to surround the data storage device.

10. The data capture device as claimed in claim 1 wherein said data sensor comprises an audio sensor.

11. The data capture device as claimed in claim 1 wherein the data storage device is an MP3 player.

12. A method of storing data comprising the steps of:
sensing data with a data sensor of a data capture device;
converting said data to binary code by said data capture device;
transferring said binary code to a data storage medium of a data storage device.

13. The method as claimed in claim 12 further comprising the step of placing data obtained in said sensing step into a first data buffer and compressing and wherein said converting step comprises the steps of compressing and encoding said data into a second data buffer.

14. The method as claimed in claim 13 wherein said transferring step comprises the step of copying said compressed and encoded data to said data storage medium of said data storage device.

15. The method as claimed in claim 12 wherein said data sensor comprises an image sensor.

16. The method as claimed in claim 12 wherein said data sensor comprises an audio sensor.

17. A method of transferring data comprising the steps of:
sensing data with a data sensor of a data capture device;
converting said data to binary code by said data capture device;
transferring said binary code to a display screen of a data storage device.

18. The method as claimed in claim 17 further comprising the step of placing data obtained in said sensing step into a first data buffer and compressing and wherein said converting step comprises the steps of compressing and encoding said data into a second data buffer.

19. The method as claimed in claim 18 wherein said transferring step comprises the step of copying said compressed and encoded data to said data storage medium of said data storage device.

20. The method as claimed in claim 17 wherein said data sensor comprises an image sensor.
